(19) United States
(12) Patent Application Publication
(10) Pub. No.: US 2022/0373818 A1
(43) Pub. Date: Nov. 24, 2022

(54) DISPLAY DEVICE

(71) Applicant: ALPS ALPINE CO., LTD., Tokyo (JP)

(72) Inventors: Katsunari Ashimine, Iwaki (JP); Hiroki Sato, Sendai (JP)

(73) Assignee: ALPS ALPINE CO., LTD., Tokyo (JP)

(21) Appl. No.: 17/744,914

(22) Filed: May 16, 2022

(30) Foreign Application Priority Data
May 24, 2021 (JP) 2021-086656

(51) Int. Cl. G02B 30/40; G02B 5/02; G02B 27/28; G02B 27/00

(52) U.S. Cl. CPC G02B 30/40; G02B 5/0252; G02B 27/283; G02B 27/0093

(57) ABSTRACT

One form of a display device of the present disclosure includes a first optical structure and a second optical structure stacked on the first optical structure. The first optical structure includes a light source, a light guide layer, a reflection layer, and a half mirror, and a light diffusion surface for generating a design of a multiple image that is formed on a bottom portion of the light guide layer. The second optical structure includes a light source, a light guide layer, a retroreflective layer, and a half mirror, and a light diffusion surface for generating a design of the aerial image is formed on a bottom portion of the light guide layer. The aerial image and the multiple image are simultaneously observed from the viewpoint of the user, and a sense of depth or a stereoscopic effect can be imparted to the aerial image.

### RELATED APPLICATION

The present application claims priority to Japanese Patent Application Number 2021-086656, filed May 24, 2021 the entirety of which is hereby incorporated by reference.

### BACKGROUND

### 1. Field of the Disclosure

The present disclosure relates to a display device that displays an image in air using retroreflection.

### 2. Description of the Related Art

JP 2013-517528 A discloses a stereoscopic display that enables stereoscopic vision by imparting a lens structure or a prism structure as a configuration for obtaining stereoscopic effect on a display. Further, aerial imaging by retro-reflection (AIRR) using retroreflection is known. For example, in order to enable observation of an image formed in the air from a wider angle, the display device of JP 2017-107165 A uses two retroreflective members, and one of the retroreflective members is arranged on the emission axis of the light source. In the image display device of JP 2018-81138 A, in order to facilitate adjustment of an image forming position of an image, a half mirror, a retroreflective member, and an image output device are disposed in parallel and a position of the half mirror or the image output device is changed so that the image forming position can be adjusted. In the image display device of JP 2019-66833 A, in order to minimize a decrease in visibility of an image, the number of times of light transmission through a phase difference member (λ/4 plate) is reduced and it is made difficult for dust or the like to enter between a retroreflective member and the phase difference member. In the aerial image display device of JP 2019-101055 A, in order to reduce a thickness of a device, a display and a retroreflective member are disposed parallel to a beam splitter and a deflection optical element is disposed on the display.

### SUMMARY

FIG. 1A illustrates an example in which a display device that displays an aerial image is applied to a spatial input device. The spatial input device 10 includes a housing (structure) 20 that accommodates a display device that generates an aerial image, and a three-dimensional distance sensor 50 that detects an approach of an object (for example, a user's finger or the like) 40 to the aerial image 30 generated above the housing 20. The aerial image 30 includes, for example, left and right scroll keys 60 and 62 and icon images 70 to 80 for instructing input as illustrated in FIG. 1B.

In a case where only the aerial image 30 is displayed, a situation often occurs in which, when the user sees the aerial image 30, the user recognizes that the aerial image 30 is displayed on the structure 20 on a back surface, and does not recognize it as the aerial image 30 in the first place. This is related to a human cognitive process, and is caused by superimposing the aerial image 30 on a background object in the brain when viewing the aerial image. When the aerial image 30 is used as a non-contact device, it is necessary to make the user visually recognize the fact, and how to make the aerial image stand out and easily recognized is a problem in implementation.

An object of the present disclosure is to address such a conventional problem, and to provide a display device capable of displaying an aerial image that is easily visually recognized, and a spatial input device using the display device.

A display device according to one form of the present disclosure capable of displaying an aerial image using retroreflection includes a first optical structure that forms a multiple image by light diffused or scattered by a first light diffusion surface of a first light guide layer, and a second optical structure that retroreflects light diffused or scattered by a second light diffusion surface of a second light guide layer to form an aerial image, in which the first optical structure and the second optical structure are in a stacked relationship, and the first light diffusion surface and the second light diffusion surface are disposed at positions not overlapping each other.

In some implementations, the first optical structure includes reflection members formed on an upper surface side and a bottom surface side of the first light guide layer, where light incident from a side portion of the first light guide layer is diffused or scattered by the first light diffusion surface formed on a bottom surface or a bottom portion of the first light guide layer.

In some implementations, the second optical structure includes a retroreflective layer formed on a bottom surface side of the second light guide layer, where light incident from a side portion of the second light guide layer is diffused or scattered by the second light diffusion surface formed on a bottom surface or a bottom portion of the second light guide layer.

In some implementations, the second optical structure is stacked on the first optical structure, the first optical structure includes a reflection layer, a first light guide layer formed on the reflection layer, and a beam splitter formed on the first light guide layer, and the second optical structure includes a retroreflective layer, a second light guide layer formed on the retroreflective layer, and a beam splitter formed on the second light guide layer, and a multiple image formed by the first light diffusion surface of the first light guide layer and an aerial image formed by the second light diffusion surface of the second light guide layer can be simultaneously observed from above the second optical structure.

In some implementations, the first optical structure is stacked on the second optical structure, the second optical structure includes a retroreflective layer and a second light guide layer formed on the retroreflective layer, and the first optical structure includes a reflection layer, a first light guide layer formed on the reflection layer, and a beam splitter formed on the first light guide layer, and a multiple image formed by the first light diffusion surface of the first light guide layer and an aerial image formed by the second light diffusion surface of the second light guide layer can be simultaneously observed from above the first optical structure.

In some implementations, a color of light incident on the first light guide layer is different from a color of light incident on the second light guide layer. In one aspect, the second optical structure further includes a λ/4 plate between a second light guide layer and the retroreflective layer, and a beam splitter formed on an upper surface of the second light guide layer is a polarization beam splitter.

Forms of a spatial input device according to the present disclosure includes the display device described above, and a detection unit that detects an approach of an object to an aerial video displayed by the display device.

In the present disclosure, since the aerial image and the multiple image are simultaneously formed, a sense of depth or a stereoscopic effect is imparted to the aerial image by the multiple image, and the aerial image is made conspicuous, by which visual attraction of the aerial image is enhanced, and the aerial image is easily recognized.

### BRIEF DESCRIPTION OF THE DRAWINGS

FIGS. 1A and 1B are views illustrating a configuration example in which a conventional display device that displays an aerial image is applied to a spatial input device;

FIG. 2A is a schematic cross-sectional view of a display device according to a first embodiment of the present disclosure;

FIG. 2B is a perspective view schematically illustrating designs generated by light diffusion surfaces;

FIG. 3 is a diagram illustrating an effect of the display device according to the first embodiment of the present disclosure;

FIG. 4 is a schematic cross-sectional view illustrating a modification example of a second optical device according to the first embodiment of the present disclosure;

FIG. 5A is a schematic cross-sectional view of a display device according to a second embodiment of the present disclosure; and

FIG. 5B is a perspective view schematically illustrating designs generated by light diffusion surfaces.

### DETAILED DESCRIPTION

Embodiments and implementations of the present disclosure will be described below. A display device of the present disclosure displays a video using retroreflection in a three-dimensional space without wearing special glasses or the like. In some implementations, a display device of the present disclosure is applied to a user input interface using a video displayed in the air. It should be noted that the drawings referred to in the following description of embodiments include exaggerated display in order to facilitate understanding of the disclosure, and do not directly represent the shape and scale of an actual product.

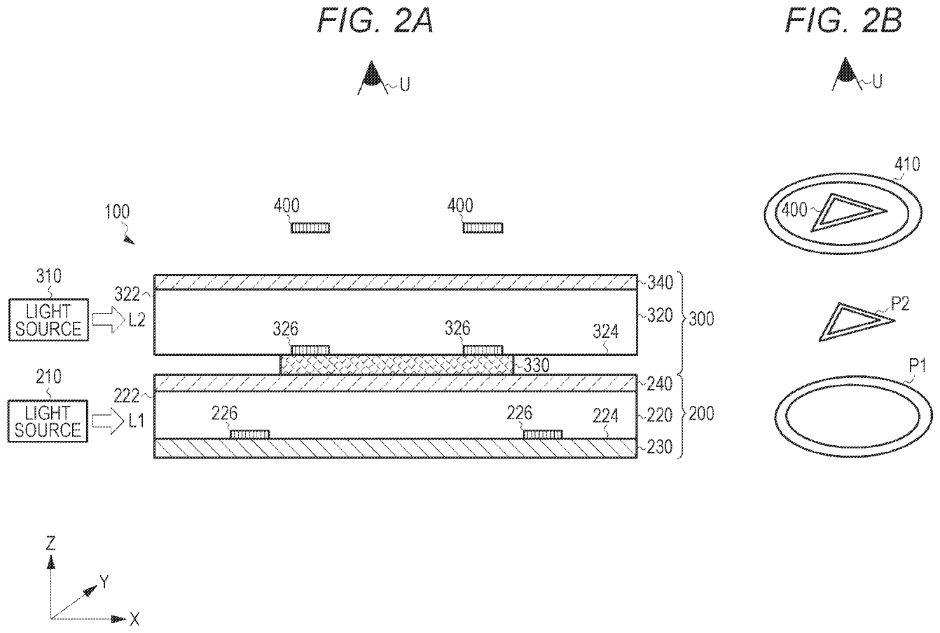

An embodiment of the present disclosure will be described in detail below. FIG. 2A is a schematic cross-sectional view of one form of a display device that displays an aerial image according to the first embodiment of the present disclosure, and FIG. 2B is a perspective view schematically illustrating designs of light diffusion surfaces formed in light guide layers.

In the display device of the present embodiment, two light guide layers are stacked, an aerial image is formed by a light diffusion surface of one of the light guide layers, and a multiple image with a sense of depth is formed around or outside the aerial image by a light diffusion surface of the other light guide layer, thereby making the aerial image conspicuous, enhancing visual attraction, and facilitating visual recognition of the aerial image.

As illustrated in the drawing, the display device 100 includes a first optical structure 200 and a second optical structure 300 disposed above the first optical structure 200. The first optical structure 200 includes a light source 210, a light guide layer 220, a reflection layer 230 disposed below the light guide layer 220, and a half mirror 240 disposed above the light guide layer 220.

The light source 210 emits light L1 having a constant emission angle (or radiation angle) in the X direction. The emitted light L1 enters the inside from a side portion 222 of the transparent light guide layer 220, and uniformly irradiates the inside of the light guide layer 220. The light source 210 is not particularly limited, but for example, a light emitting diode, a laser diode, or the like is used. The color (wavelength) of the light L1 emitted from the light source 210 is not particularly limited, but may be the same as or different from the color of the light L2 emitted from the second light source 310, for example. Further, in a case where the side portion 222 of the light guide layer 220 has a certain length in the Y direction, a plurality of the light sources 210 may be arranged along the Y direction of the side portion 222 of the light guide layer 220. Furthermore, although the light L1 is incident from one side portion of the light guide layer 220, the light may be incident from both side portions.

The light guide layer 220 is a transparent plate-like or film-like optical member including a flat upper surface, a flat lower surface, and side surfaces connecting the upper surface and the lower surface. As the light guide layer 220, a known one can be used, and is made of, for example, glass, acrylic plastic, polycarbonate resin, cycloolefin-based resin, or the like. The light guide layer 220 has a constant thickness in the Z direction in order to allow the light L1 from the light source 210 to enter from the side portion 222.

A light diffusion surface 226 for diffusion the incident light L1 in the Z direction is formed on a bottom portion or a bottom surface 224 of the light guide layer 220. The light diffusion surface 226 is formed, for example, by performing laser processing or printing processing on the bottom surface 224 of the light guide layer 220. The light diffusion surface 226 generates a design (original image) for forming a multiple image around or outside the aerial image, and the design is arbitrarily determined in relation to the aerial image. In the example of the drawings, the light diffusion surface 226 is processed to produce a ring-shaped or annular design P1.

The reflection layer 230 is disposed so as to be in contact with the bottom surface 224 of the light guide layer 220. The reflection layer 230 is, for example, a plate-shaped, film-shaped, or thin-film-shaped member having the same shape as the bottom surface 224 of the light guide layer 220, and the material thereof is not particularly limited. The reflection layer 230 totally reflects the light L1 incident on the light guide layer 220.

The half mirror 240 is disposed so as to be in contact with the upper surface of the light guide layer 220. The half mirror 240 is, for example, a transparent optical member having the same shape as the upper surface of the light guide layer 220 and separating incident light into reflected light and transmitted light. The half mirror 240 is configured by, for example, forming a dielectric multilayer film, an anti-reflection film, or the like on a front surface or a back surface of a substrate such as flat glass or plastic. Here, the half mirror 240 in which an amount of reflected light and an amount of transmitted light are equal to each other is exemplified, but a beam splitter in which a ratio between the amount of reflected light and the amount of transmitted light is different in accordance with the luminance of the light source 210 or the luminance of the aerial image may be used.

The light L1 incident from the side portion 222 of the light guide layer 220 travels in the X direction, is diffused or scattered in the Z direction by the light diffusion surface 226, and the light diffused or scattered by the light diffusion surface 226 repeats multiple reflection between the reflection layer 230 and the half mirror 240. When the user observes from a viewpoint U in the Z direction, a multiple virtual image of the design P1 is generated on the back surface of the first optical structure 200 due to the effect of facing mirrors.

The second optical structure 300 includes a light source 310, a light guide layer 320, a retroreflective layer 330 disposed below the light guide layer 320, and a half mirror 340 disposed above the light guide layer 320.

The light source 310 emits light L2 having a constant emission angle (or radiation angle) in the X direction. The emitted light L2 enters the inside from the side portion 322 of the transparent light guide layer 320, and uniformly irradiates the inside of the light guide layer 320. The light source 310 includes, similar to the light source 210, one or a plurality of light emitting diodes or laser diodes, for example. Note that in a case where the light L2 of the light source 310 and the light L1 of the light source 210 have the same color, light emitted from a single light source may be divided into two by a beam splitter or the like, and the divided light may be emitted to the light guide layers 220 and 320, respectively.

The light guide layer 320 is a transparent plate-like or film-like optical member including a flat upper surface, a flat lower surface, and side surfaces connecting the upper surface and the lower surface, and is formed of a member similar to the light guide layer 220. The light guide layer 320 has a constant thickness in the Z direction in order to allow the light L2 of the light source 310 to enter from the side portion 322.

A light diffusion surface 326 for diffusing the incident light in the Z direction is formed on the bottom portion or a bottom surface 324 of the light guide layer 320. The light diffusion surface 326 is formed, for example, by performing laser processing or printing processing on the bottom surface 324 of the light guide layer 320. The light diffusion surface 326 generates a design (original image) for forming an aerial image, and the design is arbitrarily determined. In the example of the figure, the light diffusion surface 326 is located inside or on an inner periphery of the light diffusion surface 226, and is processed so as to generate a triangular design P2 in which an opening is formed at the center.

The retroreflective layer 330 is formed so as to be in contact with the bottom surface of the light guide layer 320. The retroreflective layer 330 is an optical member that reflects light in the same direction as the incident light, and is not particularly limited in its configuration but includes, for example, prismatic retroreflective elements such as triangular pyramid retroreflective elements and full cube corner retroreflective elements, or bead retroreflective elements. The retroreflective layer 330 is disposed at a position not interfering with the light diffusion surface 226, that is, at a position inside the light diffusion surface 226, and is disposed so as to substantially overlap the light diffusion surface 326 (here, since the design P2 has an opening at the center, the opening is shielded).

The half mirror 340 is disposed so as to be in contact with the upper surface of the light guide layer 320. The half mirror 340 has, for example, the same shape as the upper surface of the light guide layer 320, and is configured similarly to the half mirror 240. Here, the half mirror 340 in which the amount of reflected light and the amount of transmitted light are equal to each other is exemplified, but a beam splitter in which a ratio between the amount of reflected light and the amount of transmitted light is different in accordance with the luminance of the light source 310 or the luminance of the aerial image may be used.

The light L2 incident from the side portion 322 of the light guide layer 320 travels in the X direction and is diffused or scattered in the X direction by the light diffusion surface 326, a part of the diffused or scattered light is reflected by the half mirror 340, and the reflected light is incident on the retroreflective layer 330. The light incident on the retroreflective layer 330 is reflected in the same direction as the incident light, and a part thereof is transmitted through the half mirror 340 and forms an image again. An aerial image 400 of the design P2 floating up from the second optical structure 300 is observed from the viewpoint U of the user in the Z direction. Further, simultaneously with the aerial image 400, a multiple image 410 of the design P1 generated on the outer periphery of the aerial image 400 is also observed.

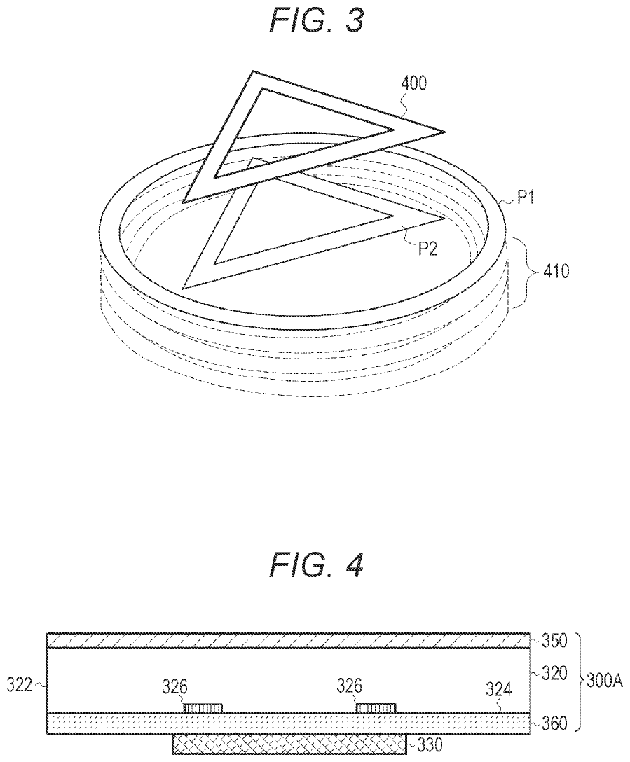

FIG. 3 is a perspective view schematically illustrating a relationship between the multiple image 410 of the design P1 and the aerial image 400 of the design P2. The first optical structure 200 generates multiple reflection of the design P1 due to the effect of facing mirrors and produces the multiple virtual image 410 having a depth feeling equal to or greater than the thickness of a real object. The second optical structure 300 forms the aerial image 400 of the design P2 inside or around the multiple virtual image 410. By representing the multiple virtual image 410 around the aerial image 400, it is possible to achieve performance in which the aerial video floats at the center of the image having a sense of depth by the display device 100 having a small/thin stacked structure.

As described above, by optically arranging the design P1 of the first layer and the design P2 of the second layer in a thin aerial video element in which the two layers are combined so that the design P1 of the first layer and the design P2 of the second layer can be simultaneously viewed, the stereoscopic effect of the aerial image 400 is emphasized, the visual attraction is increased, and the probability of being recognized as the aerial display even at the first sight can be increased. Further, the aerial image 400 can be made more conspicuous by making the color of the light source 210 different from the color of the light source 310.

It will be appreciated that the second optical structure for generating the aerial image is not limited to the configuration of FIGS. 2A and 2B, and may have a configuration as illustrated in FIG. 4, for example. In a second optical structure 300A, the polarization beam splitter 350 is disposed on the upper portion of the light guide plate 320 instead of the half mirror 340, and the λ/4 plate 360 is disposed between the light guide layer 320 and the retroreflective layer 330.

The polarization beam splitter 350 is a polarization separation element capable of dividing incident light into a p-polarization component and an s-polarization component, and can transmit a light component linearly polarized in a certain specific direction. If the light L2 incident from the light source 310 is unpolarized light including various polarization components, a part of the light reflected by the light diffusion surface 326 is transmitted through the polarization beam splitter 350, and the other light is reflected by the polarization beam splitter 350. If the light L2 incident from the light source 310 is linearly polarized light, the direction of the linearly polarized light transmitted by the polarization beam splitter 350 is set to be different from the direction of the linearly polarized light of the incident light L2, and most of the light L2 is reflected by the polarization beam splitter 350.

The λ/4 plate 360 gives a phase difference π/2 (90 degrees) to the light incident from the light guide layer 320 and transmits the light. For example, when linearly polarized light is incident, it is converted into circularly polarized light (or elliptically polarized light), and when circularly polarized light (or elliptically polarized light) is incident, it is converted into linearly polarized light.

The retroreflective layer 330 reflects the light transmitted through the λ/4 plate 360 in the same direction as the incident light. When the light reflected by the retroreflective layer 330 is transmitted through the λ/4 plate 360 again, a phase difference π/2 is given. Thus, the light transmitted through the λ/4 plate 360 has a phase difference π from the light incident on the λ/4 plate 360. For example, if the light incident on the λ/4 plate 360 is linearly polarized light, the light becomes circularly polarized light (or elliptically polarized light) when it is transmitted through the λ/4 plate 360, when this circularly polarized light is retroreflected an odd number of times by the retroreflective layer 330, the circularly polarized light becomes circularly polarized light in the opposite direction, and when this circularly polarized light in the opposite direction is transmitted through the λ/4 plate 360, it becomes linearly polarized light in a direction 180 degrees different from the original linearly polarized light. In this manner, when the light transmitted through the λ/4 plate 360 is incident on the polarization beam splitter 350, most of the reflected light is transmitted through the polarization beam splitter 350, the transmitted light forms an image, and an aerial image is formed.

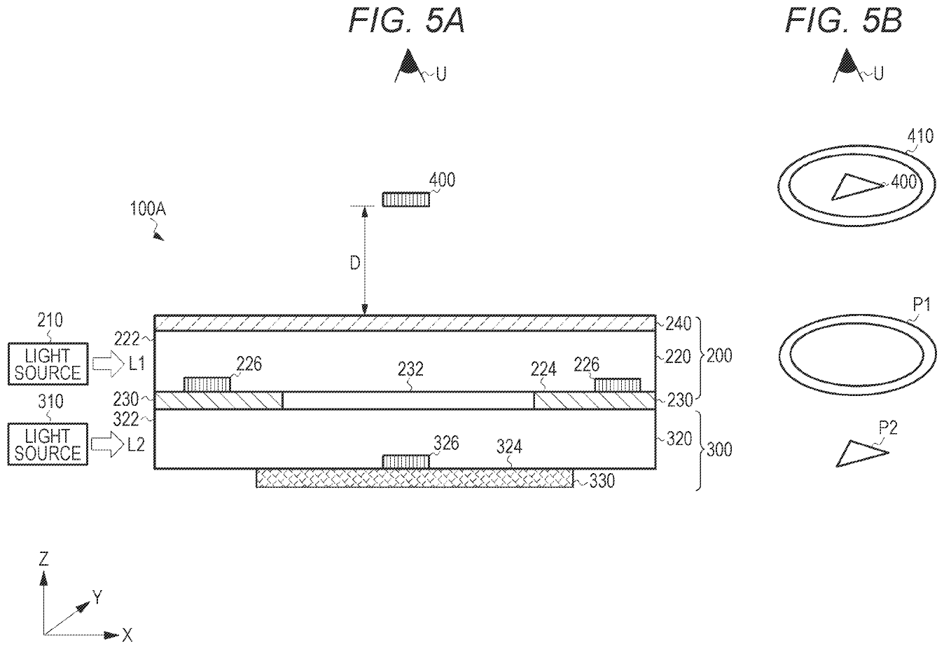

Next, a display device 100A according to a second embodiment of the present disclosure is illustrated in FIGS. 5A and 5B. In forms of the display device 100A of the present embodiment, the stacking direction is reversed from that of the first embodiment, and the first optical structure 200 is stacked above the second optical structure 300. The light diffusion surface 326 is formed on the bottom surface 324 of the light guide layer 320 of the second optical structure 300. The light diffusion surface 326 is processed to form the triangular design P2. The retroreflective layer 330 is disposed on the bottom surface of the light guide layer 320 so as to generate the aerial image 400 of the design P2.

On the other hand, the light diffusion surface 226 is formed on the outer peripheral portion of the bottom surface 224 of the light guide layer 220 of the first optical structure 200. The light diffusion surface 226 is processed to form the ring-shaped design P1. The design P1 is formed at a position not overlapping with the design P2. A ring-shaped reflection layer 230 is formed below the light diffusion surface 226. The opening 232 at the center of the reflection layer 230 has a size that exposes the light diffusion surface 326 and the retroreflective layer 330 so that the aerial image 400 is not shielded. That is, a part of the light diffused or scattered in the Z direction by the light diffusion surface 326 is reflected by the half mirror 240 of the first optical structure 200 via the opening 232, the reflected light is incident on the retroreflective layer 330, this incident light is reflected by the retroreflective layer 330 in the same direction, and a part of this reflected light is transmitted through the half mirror 240 to generate the aerial image 400.

In this manner, in the video viewed from the viewpoint U of the user, the multiple virtual image 410 of the design P1 generated by the first optical structure 200 is projected around the aerial image 400 of the design P2 generated by the second optical structure 300, the sense of depth is imparted to the aerial image 400, and recognition of the aerial image becomes easy. Further, in the present embodiment, by arranging the second optical structure 300 below the first optical structure 200, a distance D at which the aerial image 400 floats up can be made larger than that in the first embodiment, and an aerial image with a more stereoscopic effect can be displayed.

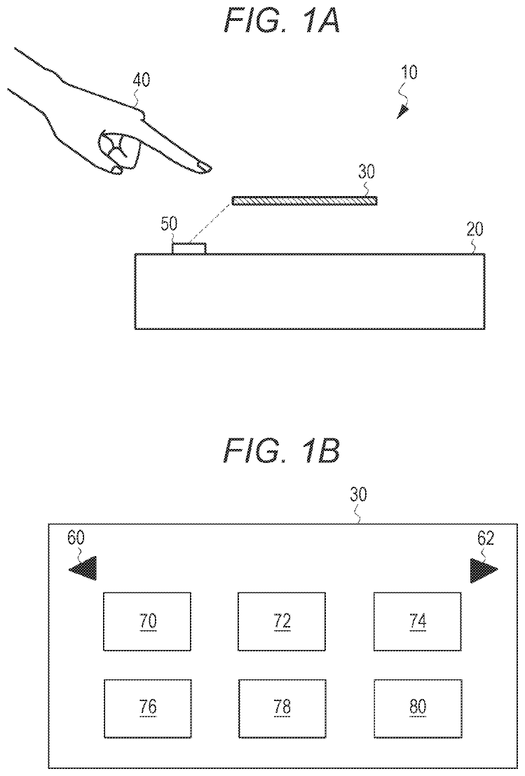

Next, a third embodiment of the present disclosure will be described. The third embodiment relates to a spatial input device in which the display device of the first or second embodiment is applied to a user input interface. As described with reference to FIGS. 1A and 1B, forms of a spatial input device includes a sensor that causes the display devices 100 and 100A of the present embodiment to display the aerial image 400 and detects an approach of an object (for example, a user's finger or the like) to the aerial image 400. The configuration of the sensor is not particularly limited, but for example, the sensor detects the approach of an object by a three-dimensional distance sensor, or detects the proximity of an object by analyzing image data captured by an imaging camera.

The spatial input device of the present embodiment can be applied to any user input, and can be applied to, for example, a computer device, an in-vehicle electronic device, an ATM of a bank or the like, a ticket purchasing machine of a station or the like, an input button of an elevator, and the like.

Although embodiments and implementations of the present disclosure have been described in detail above, the present disclosure is not limited to the specific embodiments, and various modifications and changes can be made within the scope of the gist of the disclosure set forth in the claims. Therefore, it is intended that this disclosure not be limited to the particular embodiments disclosed, but that the disclosure will include all embodiments falling within the scope of the appended claims.

What is claimed is:

1. A display device capable of displaying an aerial image using retroreflection, the display device comprising:
a first optical structure configured to form a multiple image with light diffused or scattered by a first light diffusion surface of a first light guide layer; and
a second optical structure configured to retroreflect light diffused or scattered by a second light diffusion surface of a second light guide layer and to form an aerial image,
wherein the first optical structure and the second optical structure are in a stacked relationship, and the first light diffusion surface and the second light diffusion surface are disposed at positions that do not overlap each other.

2. The display device according to claim 1, wherein the first optical structure includes reflection members formed on an upper surface side and a bottom surface side of the first light guide layer, and light incident from a side portion of the first light guide layer is diffused or scattered by the first light diffusion surface formed on a bottom surface or a bottom portion of the first light guide layer.

3. The display device according to claim 1, wherein the second optical structure includes a retroreflective layer formed on a bottom surface side of the second light guide layer, and light incident from a side portion of the second light guide layer is diffused or scattered by the second light diffusion surface formed on a bottom surface or a bottom portion of the second light guide layer.

4. The display device according to claim 3, wherein:
the second optical structure is stacked on the first optical structure, the first optical structure includes a reflection layer, a first light guide layer formed on the reflection layer, and a beam splitter formed on the first light guide layer, and the second optical structure includes a retroreflective layer, a second light guide layer formed on the retroreflective layer, and a beam splitter formed on the second light guide layer, and
a multiple image formed by the first light diffusion surface of the first light guide layer and an aerial image formed by the second light diffusion surface of the second light guide layer are configured to be simultaneously observed from above the second optical structure.

5. The display device according to claim 4, wherein a color of light incident on the first light guide layer is different from a color of light incident on the second light guide layer.

6. The display device according to claim 4, wherein:
the first optical structure is stacked on the second optical structure, the second optical structure includes a retroreflective layer and a second light guide layer formed on the retroreflective layer, and the first optical structure includes a reflection layer, a first light guide layer formed on the reflection layer, and a beam splitter formed on the first light guide layer, and
a multiple image formed by the first light diffusion surface of the first light guide layer and an aerial image formed by the second light diffusion surface of the second light guide layer are configured to be simultaneously observed from above the first optical structure.

7. The display device according to claim 6, wherein a color of light incident on the first light guide layer is different from a color of light incident on the second light guide layer.

8. The display device according to claim 3, wherein:
the second optical structure further includes a λ/4 plate between a second light guide layer and the retroreflective layer, and
a beam splitter formed on an upper surface of the second light guide layer is a polarization beam splitter.

9. The display device according to claim 2, wherein:
the second optical structure is stacked on the first optical structure, the first optical structure includes a reflection layer, a first light guide layer formed on the reflection layer, and a beam splitter formed on the first light guide layer, and the second optical structure includes a retroreflective layer, a second light guide layer formed on the retroreflective layer, and a beam splitter formed on the second light guide layer, and
a multiple image formed by the first light diffusion surface of the first light guide layer and an aerial image formed by the second light diffusion surface of the second light guide layer are configured to be simultaneously observed from above the second optical structure.

10. The display device according to claim 2, wherein:
the first optical structure is stacked on the second optical structure, the second optical structure includes a retroreflective layer and a second light guide layer formed on the retroreflective layer, and the first optical structure includes a reflection layer, a first light guide layer formed on the reflection layer, and a beam splitter formed on the first light guide layer, and
a multiple image formed by the first light diffusion surface of the first light guide layer and an aerial image formed by the second light diffusion surface of the second light guide layer are configured to be simultaneously observed from above the first optical structure.

11. The display device according to claim 10, wherein a color of light incident on the first light guide layer is different from a color of light incident on the second light guide layer.

12. The display device according to claim 2, wherein:
the second optical structure further includes a λ/4 plate between a second light guide layer and the retroreflective layer, and
a beam splitter formed on an upper surface of the second light guide layer is a polarization beam splitter.

13. The display device according to claim 1, further comprising a detection unit that detects an approach of an object to an aerial video displayed by the display device.
